(19) United States
(12) Patent Application Publication
(10) Pub. No.: US 2026/0340772 A1
(43) Pub. Date: Oct. 29, 2026

(54) IMAGE PROCESSING APPARATUS, IMAGE PROCESSING METHOD, AND IMAGE PROCESSING PROGRAM

(71) Applicant: XO LAB LIMITED, Kowloon (HK)

(72) Inventor: Michinori FUJIMORI, Tokyo (JP)

(21) Appl. No.: 19/655,287

(22) Filed: Apr. 22, 2026

(30) Foreign Application Priority Data
Apr. 24, 2025 (JP) 2025-072608

(51) Int. Cl. G06T 5/20; G06V 10/22

(52) U.S. Cl. CPC G06T 5/20; G06V 10/22; G06T 2207/30196

(57) ABSTRACT

There is a case where it is difficult to cope with an object body in which automatic recognition of a target part is difficult in reducing workload of image shielding processing such as mosaic processing of private parts and a chest. In addition, it is difficult to immediately perform image processing suitable for the live distribution video. An image processing apparatus of the present invention includes any one or a plurality of a first specifying unit that specifies a region detected by a model constructed by machine learning as a target region, a second specifying unit that specifies the target region by correcting the constructed model based on a feature amount of a region specified by an external operation, and a third specifying unit that specifies a non-target region based on a feature amount of a region specified by an external operation.

### TECHNICAL FIELD

The present invention relates to an image processing apparatus, an image processing method, and an image processing program that perform processing on an image whose transmission is legally restricted.

### BACKGROUND ART

There exist items that are legally restricted from being published or distributed. Article 175 of Penal Code of Japan stipulates to the effect that a person who distributes or displays in public obscene objects such as documents, drawings or recording media contained in electromagnetic records is subject to a penalty, and the same applies to a person who distributes an obscene electromagnetic record or other records by transmission of telecommunication. "Act on Punishment of Activities Relating to Child Prostitution and Child Pornography, and the Protection of Children" also prohibits the possession or provision of electromagnetic records recording information depicted by a method capable of visually recognizing “child pornography” as defined in each item of Article 2, Paragraph 3 of the same Act. Furthermore, in a case where a moving image in which genitals are exposed is distributed or a sex image is distributed without censorship in live distribution of the moving image, there is a possibility that the case may be charged with public indecency stipulated in Article 174 of Penal Code of Japan.

Therefore, in order to avoid such legal restrictions from the viewpoint of compliance, a shielding processing (mosaic processing, blurring processing, and other processing of making original image invisible) is performed on a specific region of an image, but most of such processing is actually performed manually.

However, in such processing, particularly in a case where the image is a moving image, it is necessary to perform work for each frame, and considerable labor and cost are required.

Furthermore, in the case of live distribution of a moving image, a means for immediately performing shielding processing on a desired portion of a captured image has not been provided.

Meanwhile, the following is proposed as a technique for automatically processing an image.

JP 2020-197833 A discloses a data augmentation system including an input unit configured to input data to a trained machine learning model that performs recognition, an identification unit configured to identify a characteristic portion of the input data based on recognition performed by the machine learning model after the input data is input, a processing unit configured to acquire processing data by processing at least a part of the identified characteristic portion, and a data augmentation unit configured to perform data augmentation in order to perform additional learning of the machine learning model on the basis of the processing data. WO 2018/225775 proposes an image masking device including an image input receiving unit that receives an input of an image, a masking target portion extracting unit that automatically extracts a masking target portion from the input image, a masking applying unit that applies masking to the extracted masking target portion, and an image output unit that outputs the masked image. In addition, JP 2024-78242 A proposes an image processing apparatus including an image acquisition unit that acquires an image by an imaging device, an object detection unit that detects an object in the image, a region designation unit that designates a region including at least personal information or information regarding privacy with respect to the object output from the object detection unit, and an image processing unit that performs shielding processing for making the region designated by the region designation unit indistinguishable.

### SUMMARY OF INVENTION

### Technical Problem

However, any of the disclosed technologies has the following problem:
1. there is a case where it is difficult to cope with an object in which automatic recognition of a shielding processing target part is difficult,
2. there is a case where a shielding target is displayed on an image or hidden by a specific object (for example, “hand”) due to the characteristics of content, and necessity of shielding processing may be intermittently changed, but it is not possible to cope with such processing, and
3. it is difficult to cope with live distribution.

### Solution to Problem

Therefore, in order to solve such a problem, the present invention has the following configuration.
1.An image processing apparatus according to the present invention includes: an image input unit that inputs an image in which at least one human body is captured; a target region specifying unit that specifies a target region (however, the face region is excluded) in the image; and an image processing unit that performs shielding processing on the specified target region, in which the shielding processing includes any one or a plurality of mosaic processing, blurring processing, blending processing, processing of superimposing another image on the target region, and processing of replacing the image with another image, the target region specifying unit includes any one or a plurality of a first specifying unit that specifies a region detected by a model constructed by machine learning as a target region, a second specifying unit that specifies the target region by correcting the constructed model based on a feature amount of a region specified by an external operation, and a third specifying unit that specifies a non-target region based on a feature amount of a region specified by an external operation.
2. The model in the first specifying unit may detect the target region by using an algorithm pre-trained by machine learning using a clothed or unclothed state of a human body as training data.
3. Alternatively, the model in the first specifying unit may detect the target region by using an algorithm pre-trained by machine learning using skeleton information or posture information of a human body as training data.
4. In addition, the image processing apparatus according to the present invention may further include a face region specifying unit that specifies a face region in the image, in which a position of the target region specified on the basis of a positional relationship with the face region is corrected.
5. Note that the image processing apparatus according to the present invention may be configured such that the image is a moving image, and with respect to a target region specified in one frame, corresponding regions in a plurality of consecutive frames are also regarded as target regions, and frame interpolation processing is performed.
6. In addition, the image processing apparatus according to the present invention may further include a risk score calculation unit for each frame, in which, when an integrated value of risk scores in a plurality of consecutive predetermined frames exceeds a predetermined value, shielding processing is performed on a predetermined region of the image.
7.An image processing method according to an aspect of the present invention includes: an image input step of inputting an image in which at least one human body is captured; a target region specifying step of specifying a target region (however, the face region is excluded) in the image; and an image processing step of performing shielding processing on the specified target region, in which the shielding processing includes any one or a plurality of mosaic processing, blurring processing, blending processing, processing of superimposing another image on the target region, and processing of replacing the image with another image, the target region specifying step includes any one or a plurality of steps of a first specifying step of specifying a region detected by a model constructed by machine learning as a target region, a second specifying step of specifying the target region by correcting the constructed model based on a feature amount of a region specified by an external operation, and a third specifying step of specifying a non-target region based on a feature amount of a region specified by an external operation.
8. Further, an image processing program according to an embodiment of the present invention causes a computer to function as: an image input unit that inputs an image in which at least one human body is captured; a target region specifying unit that specifies a target region (however, the face region is excluded) in the image; and an image processing unit that performs shielding processing on the specified target region, in which the shielding processing includes any one or a plurality of mosaic processing, blurring processing, blending processing, processing of superimposing another image on the target region, and processing of replacing the image with another image, the target region specifying unit includes any one or a plurality of a first specifying unit that specifies a region detected by a model constructed by machine learning as a target region, a second specifying unit that specifies the target region by correcting the constructed model based on a feature amount of a region specified by an external operation, and a third specifying unit that specifies a non-target region based on a feature amount of a region specified by an external operation.
9.Furthermore, an image processing apparatus according to an embodiment of the present invention is an image processing apparatus including: an image input unit that inputs a video in which at least one human body is captured; a target region specifying unit that specifies a target region (however, the face region is excluded) in each of consecutive frames constituting the video; and an image processing unit that performs shielding processing on the specified target region, in which the target region specifying unit includes a first target region specifying unit that specifies a region recognized using a trained model constructed by machine learning as a target region and a second target region specifying unit that executes processing when interpolation processing occurs in a predetermined number of consecutive frames.
10. The image processing apparatus according to an embodiment of the present invention may further include a correction target region specifying unit that specifies, as a target region, a region recognized using a trained model reconstructed on the basis of image information of a region specified by an external operation in the video, in parallel with the specification by the first target region specifying unit. Alternatively, the image processing apparatus may further include a correction target region specifying unit that specifies, as a target region, a region recognized using a trained model reconstructed on the basis of image information of a region specified by an external operation in the video, after specification by the first target region specifying unit.
11. The image processing apparatus may further include a correction target region specifying unit that specifies, as a target region, a region recognized using a trained model reconstructed on the basis of image information of a region specified by an external operation in the video, after specification by the first target region specifying unit. Alternatively, a processing load of the second target region specifying unit may be larger than that of the first target region specifying unit, and the processing by the second target region specifying unit may be a combination of the skeleton estimation model and the face detection model.

In the present invention, the "image" includes a still image and a moving image. The "moving image" is obtained by reproducing a motion by continuously reproducing a still image called a frame at a constant speed. The "mosaic processing" refers to image processing of intentionally obscuring original image information by averaging a plurality of adjacent pixels or filling a part or the whole of an image with a specific pattern. The “blurring processing" refers to image processing that smooths color differences between pixels in an image and intentionally obscures certain portions or the entirety of the image. The "blending processing" refers to processing of combining pixel information of a plurality of images based on a specific calculation method to generate a new image.

The “model constructed by machine learning” refers to a computer program trained to learn patterns and regularity from a large amount of data and to be able to execute tasks such as prediction and classification on unknown data, and the “reconfigured trained model” refers to a model based on an existing trained model and having a structure and parameters adjusted and changed according to a specific task and purpose, and is often performed using a method such as transfer learning or fine tuning.

The “feature amount” in the present invention refers to a representation in the form of a numerical value or a vector of the content of the designated or specified image region, and color information (color distribution, average color, color histogram, and the like of the image region), texture information (pattern, texture, roughness, and the like of image surface), shape information (information such as an outline, a shape, and a corner of an object in an image), and the like can be extracted as the feature amount, but the feature amount is not limited thereto, and may be a parameter representing a more abstract and higher-dimensional feature extracted from an intermediate layer of a deep learning model, for example.

As the “clothed or unclothed state of the human body”, images in a clothed state of the entire body, an unclothed state of only the upper body, an unclothed state of only the lower body, and an unclothed state of the entire body are used as training data to train a model. Each image is desirably annotated. As the “skeleton and posture information of the human body”, in order to estimate the skeleton and estimate the positional relationship between the face and the torso, learning is performed using a learning model in which the positional relationship of each part of the human body is detected, or learning is performed using a skeleton estimation model and face detection model.

The "interpolation processing" refers to processing that makes a region subjected to shielding processing appear smooth in temporal continuity, and includes general image processing that is performed so as not to cause unnatural jumps between frames, a change in shape, and interruption of the shielding processing. The "case where the target region is not specified" refers to a state in which the unclothed state of the human body is recognized, and in a case where the corresponding region is not detected even if the region specifying processing is performed by the target region specifying unit, that is, a case where it is highly probable that there is a region where the shielding processing is to be originally performed, but the target region specifying unit cannot specify the region. A plurality of alternative means are conceivable for the processing in such a state. The most conservative means is to delete the frame from the moving image data or to perform shielding processing on the entire image of the frame. As a less restrictive means than this, it is conceivable to perform shielding processing on a region other than the face region. Alternatively, it is conceivable to maintain temporal continuity between frames by performing the above-described interpolation processing. Furthermore, by including a plurality of target region specifying units or executing respective means in a mutually complementary manner, including the possibility of application of interpolation processing thereto, it is possible to perform image processing that does not become excessively conservative while maintaining compliance.

### Advantageous Effects of Invention

According to the present invention, it is possible to more appropriately recognize a shielding processing target and perform image processing, improve accuracy and speed of image processing, and reduce labor and cost. In addition, it is possible to more appropriately recognize a unique shielding processing target region by preliminary learning and perform image processing. Furthermore, even in a case where a scene in which the shielding processing does not need to be performed intermittently occurs, such as when the shielding processing target is covered by the non-shielding processing target, the shielding processing can be appropriately performed or controlled not to be performed, and the viewer's interest is not impaired by excessively performing the shielding process.

In addition, these can be applied to the live image, and the interest of the viewer can be improved by the image in which legal safety is ensured. In particular, masking processing is simplified in an image of a specific style, for example, an image in which a single human body is a subject. In this regard, in the conventional live broadcasting, it is common to employ capturing techniques such as removing a portion to be shielded from an angle of a camera or hiding the portion using a tool. In a case where private parts are captured, there is a disadvantage that the content is directly publicly transmitted. Therefore, it is necessary to monitor the distribution content in a manned manner in order to prevent such a situation. In the present invention, it is possible to prevent private parts from being captured even without human monitoring.

### BRIEF DESCRIPTION OF DRAWINGS

FIG. 1 is a hardware configuration diagram of an image processing apparatus.

FIG. 2 is a schematic diagram illustrating a flow of image processing.

FIG. 3 is a flowchart illustrating a flow in which a shielding processing target region is determined.

FIG. 4 is a flowchart illustrating a flow of operation in a test mode.

FIG. 5 is a conceptual diagram illustrating processing contents of the image processing apparatus in a test mode.

FIG. 6 is an example of a window displayed in a test mode.

FIG. 7 is an example of a window displayed in a test mode.

FIG. 8 is a conceptual diagram illustrating a flow of reflecting an output image in reconstruction of trained data.

FIG. 9 is an example of a window displayed in a test mode.

FIG. 10 is a flowchart illustrating a flow of second image processing.

FIG. 11 is a processing flow in a case where each piece of image processing is executed in a mutually complementary manner.

### DESCRIPTION OF EMBODIMENTS

Hereinafter, an example of an embodiment of the present invention will be described with reference to the drawings. In the description, the following words may be used in the following meanings.
1. "Shielding processing": Examples of the processing include mosaic processing, blurring processing, blending processing, processing of superimposing an image, and processing of replacing an image with another image on a target region, but are not limited thereto, and a combination of a plurality of types of processing may be used.
2. "Exposure": A state in which a region to be subjected to shielding processing in image processing is displayed without shielding processing.

### Hardware Configuration Diagram

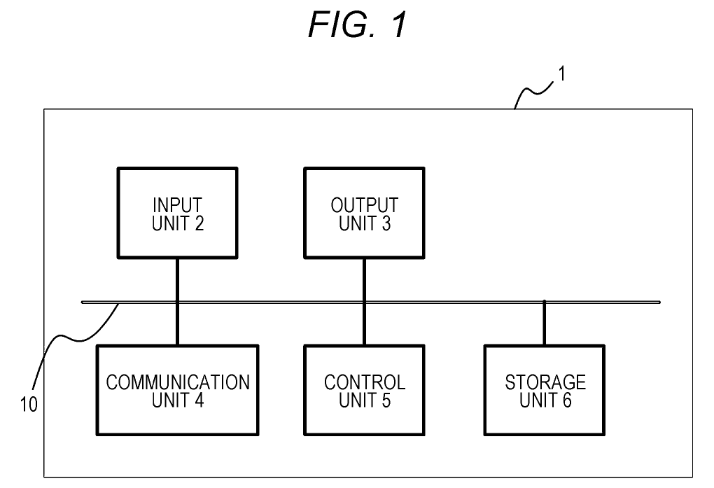

FIG. 1 illustrates a hardware configuration of an image processing apparatus 1. The image processing apparatus 1 is an information processing apparatus (computer), and includes an input unit 2, an output unit 3, a communication unit 4, a control unit 5, and a storage unit 6, and these components are electrically connected via a communication bus 10 inside the image processing apparatus 1.

The input unit 2 is a user interface that receives information from the user, and is, for example, a keyboard, a mouse, a card reader, a touch panel, or the like. The output unit 3 is a user interface that outputs (display output, audio output, print output, and the like) various types of information, and is, for example, a display device (liquid crystal display (LCD), graphic card, and the like) that displays an image, an audio output device (speaker) that outputs audio, or the like.

The communication unit 4 is a communication interface that communicates with a server (not illustrated) via a communication unit, and is, for example, a network interface card (NIC), a wireless communication module, a universal serial bus (USB) module, a serial communication module, or the like. The communication unit 4 can also function as a device that receives information from another device such as a mobile terminal or a PDA that is communicably connected. The image processing apparatus 1 communicates with an external network (not illustrated) via a communication unit by the communication unit 4.

The control unit 5 is, for example, a device that performs arithmetic processing, and is a central processing unit (CPU), a micro processing unit (MPU), a graphics processing unit (GPU), an artificial intelligence (AI) chip, or the like. The storage unit 6 is a device that stores programs and data, and is, for example, a read only memory (ROM) (static random access memory (SRAM), non volatile RAM (NVRAM), mask read only memory (mask ROM), programmable ROM (PROM), and the like), a random access memory (RAM) (a dynamic random memory (DRAM) or the like), a hard disk drive, a flash memory, a solid state drive (SSD), an optical storage device (compact disc (CD), digital versatile disc (DVD), and the like), or the like. The control unit 5 functions as a target region specifying unit (first specifying unit, second specifying unit, third specifying unit) and an image processing unit based on the trained model stored in the storage unit 6 and input information from the outside via the input unit 2 by the following processing.

Note that a plurality of GPUs may be provided from the viewpoint of load distribution of image processing to be described later. It can also be configured to dynamically monitor the resource usage of the GPU and optimize the number of GPUs allocated to each processing while measuring the processing speed of each image processing. Furthermore, the present embodiment typically refers to a case where processing is performed in one piece of hardware, that is, in a computer, but distributed processing by a plurality of computers connected via a network may be performed.

### Image Processing Flow (First Image Processing)

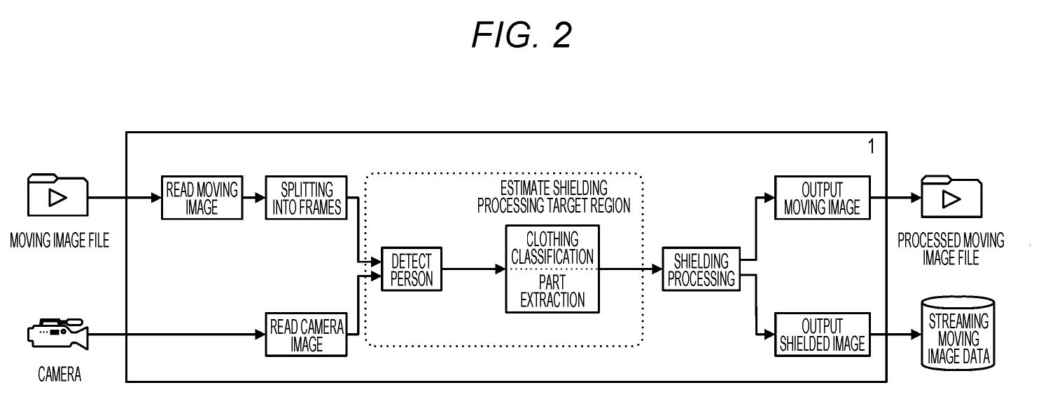

A flow of image processing will be described. FIG. 2 is a schematic diagram illustrating processing in the image processing apparatus 1 that inputs an image (moving image file or camera image) and outputs an image obtained by performing shielding processing on a specific region.

When the image processing apparatus 1 reads the moving image file MF, the image processing apparatus 1 performs image processing by dividing the moving image file MF into frame units constituting the moving image. The following processing is performed for each frame. At this time, the moving image file MF is input to the image processing apparatus 1 via the input unit 2 or the communication unit 4. The input unit 2 to the communication unit 4 correspond to image input units. The control unit 5 functions as a face region specifying unit in the following processing.
1. Person detection: A person is detected from an image. Specifically, after adjusting the size and color tone of the image and removing noise, information characterizing the person, for example, the shape and contour of the face and the color of the clothes are extracted from the image. Whether the person is included in the image is specified based on the extracted feature.
2. Clothing determination: Whether the detected person is a clothed person or an unclothed person (upper body naked, lower body naked, totally naked) is classified. The classification is a determination element of necessity of shielding processing.
3. Part detection: The position of the detected part (chest or private parts) of the person is detected. The detection is an estimation element of the shielding processing target region.

### Used Dataset and Trained Data

Note that the clothing determination and the part detection are performed using trained data generated using deep learning in which annotation (tagging) is performed on a sufficient amount of image data of each of the wearing person and the non-wearing person from the dataset for training of a NSFW image classification AI.

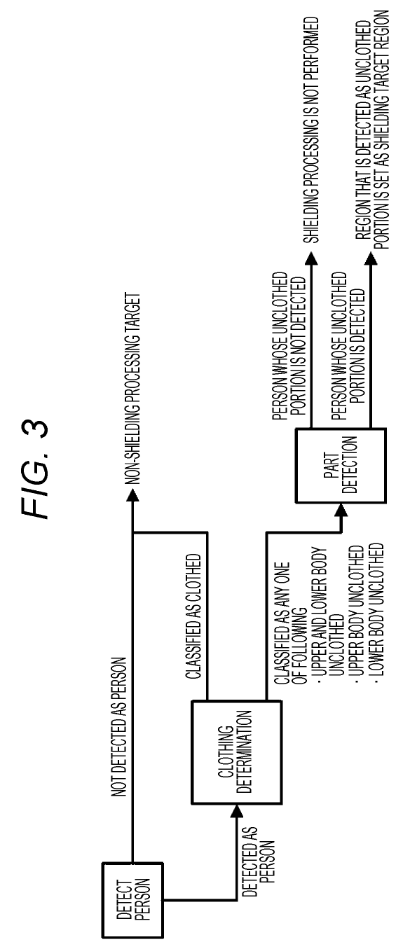

A shielding processing target region is determined by performing person detection, clothing classification, and part detection for each frame. FIG. 3 is a flowchart illustrating a flow in which the shielding processing target region is determined. A region that has not been detected in the person detection and a person that has been detected as a person but has been classified as clothed are determined to be excluded from the shielding processing target. In a case where either or both of the upper part and the lower part are determined to be unclothed in the region detected as the person, the part is detected in the subsequent part detection, and in a case where the part is unclothed, the part is determined as the shielding processing target region. On the other hand, in a case where the person is classified as unclothed but the part is not detected due to the capturing angle or the like, the shielding target region is not detected in this determination flow. Clothing determination and part detection are not necessarily performed in this order, and the order may be switched. In addition, parallel processing may be performed.

### Interpolation Processing

Note that although the shielding processing is performed on each frame, the shielding processing may not be appropriately performed in some frames. For example, in a case where the target part is temporarily hidden by an obstacle (another item, a hand of the person or another person, and the like), there is a case where the processing is not appropriately performed and exposure occurs. Tracking maintains consistency between frames so that exposure does not occur even in such a case. In the tracking, feature points of the part detected by the above-described part detection are extracted, and how the target region is moved in the subsequent frames is tracked based on the extracted feature points.

In the interpolation processing, other methods such as linear interpolation (a method of linearly estimating the region in frames before, after, or between frames from a plurality of frames), spline interpolation (tertiary spline interpolation, B-spline interpolation, NURBS, and the like), optical flow interpolation, and dynamic time warping interpolation (DTW) can also be applied or used in combination.

### Processing Flow in Test Mode

Next, shielding processing (test mode) particularly for live distribution will be described. In the test mode, before actual image distribution is started, processing of designating a region of a person image of a subject being captured and setting the region as a shielding processing target or not setting the region as a shielding processing target is performed. In addition, it is also possible to additionally perform training during distribution. Alternatively, in a case where it is recognized that an inappropriate image is distributed during distribution, the test mode can be executed again.

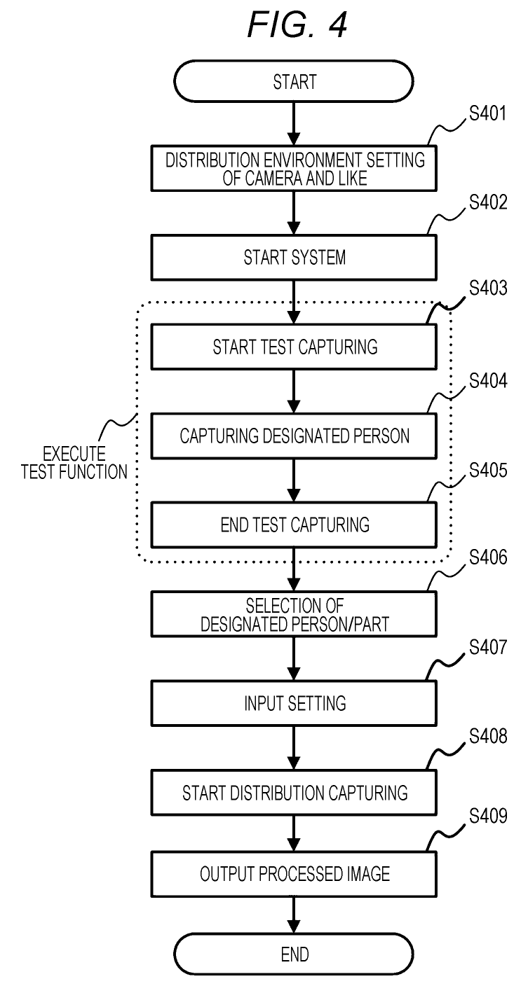

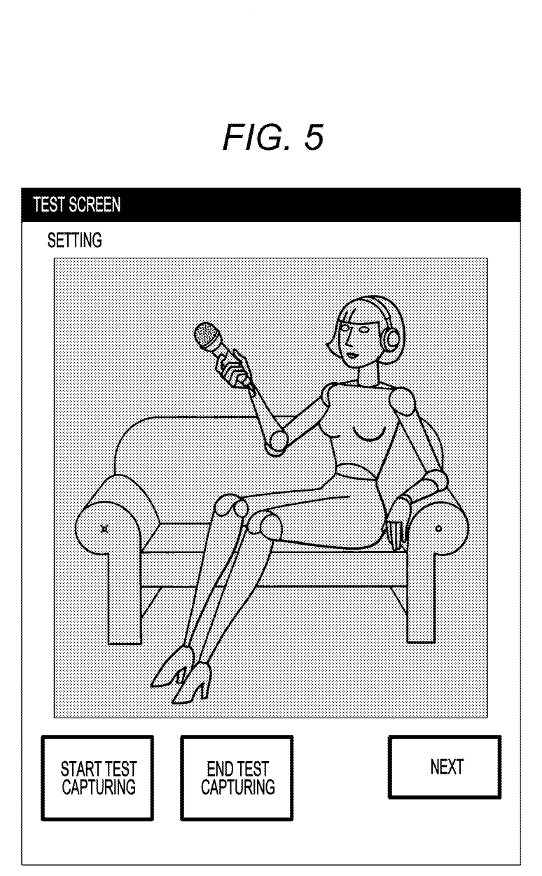

FIG. 4 is a conceptual diagram illustrating an operation flow in the test mode and processing contents of the image processing apparatus 1 in the test mode, and FIGS. 5-7 and 9 are examples of display screens at that time.
1. Start Test Capturing
   Prior to activation of the test mode, connection between the image processing apparatus 1 and a camera for distribution, and setting of a distribution environment such as communication setting are performed (step S401). When the test mode of the image processing apparatus 1 is started (step S402), a preview image in which the subject is captured is displayed on the output unit 3 as illustrated in FIG. 5. At the same time, buttons of "start test capturing" and "end test capturing" are displayed. When the test capturing start button is pressed (step S403), image capturing is started, and the image processing apparatus 1 displays a message prompting the subject to perform, for example, the following predetermined operations.
   - Slowly shake the face up and down, left and right, and diagonally to return to the front.
   - Move the face in circle
   - Tilt the neck left and right
   - Slowly look back to the left and right while keeping the line of sight horizontal.
   - The line of sight is directed to the camera, framed in from the left and right, and moves in the opposite direction.
   - Imaging is performed with a posture in which other body parts to be captured are fully visible.
Note that the video at this stage is not distributed. The image processing apparatus 1 performs fine tuning of the trained model on the basis of the obtained image data.

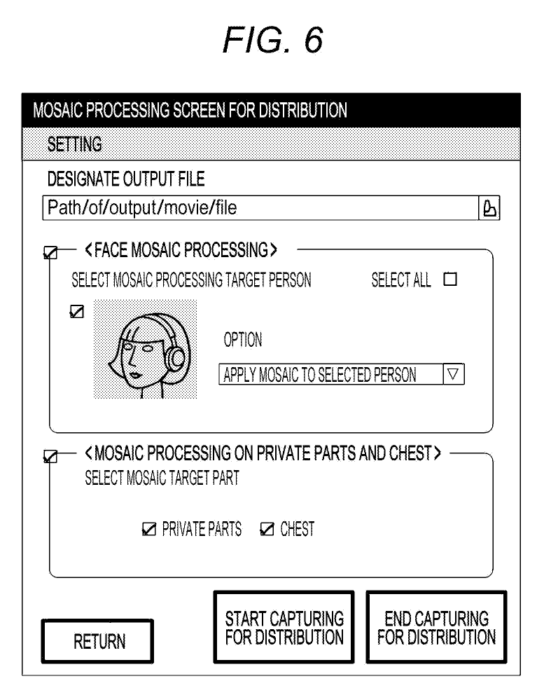

2. Selection of Person/Part
Next, the image processing apparatus 1 displays the information illustrated in FIG. 6 on the screen to prompt an operator to make an input (step S406). Specifically, an input of
a. selection of necessity of face mosaic processing
b. selection of necessity of mosaic processing of a specific part (chest or private parts)
is prompted.

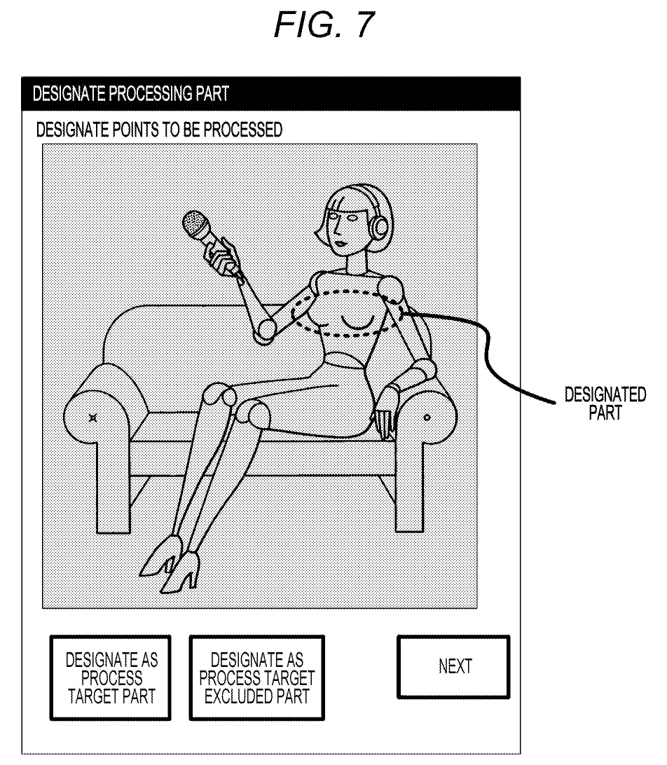

3. Input of Processing Target Part
Furthermore, in the same step, as illustrated in FIG. 7, an image recorded at the time of test capturing may be displayed on the screen together with an indication prompting the operator to “designate a portion to which processing is applied” in test capturing. The operator designates a region to be avoided from being exposed for distribution on the screen. The region designation may be repeatedly performed. Note that, in the photograph of FIG. 7, an image of a person in a clothed state is used for convenience, but actually, a portion as a shielding processing target in the person image in an unclothed state is designated by an external operation by the user. The designation operation can be performed by using an input device such as a mouse or a stencil to set a display position on the display image.

4. Determine Processing Region
Based on the region specifying information input by the operator, the image processing apparatus 1 finely tunes the parameters of the trained model. Specifically, based on the input region specifying information, one or more of the feature amount of the designated region, the color histogram or the color variation as the color information, the fine texture pattern or the gray level in the target region as the texture information, the contour or the corner information of the part as the shape information, and the quantified shape information of the part as the shape information, but are not limited thereto, are reconstructed so as to be adapted to the image processing of the subject to be distributed while being based on the trained model regarding the existing processing required part. As a result, it is possible to detect a target part such as private parts or chest having different appearances for each person in a form that fits the characteristics of the subject, and the processing accuracy can be improved.

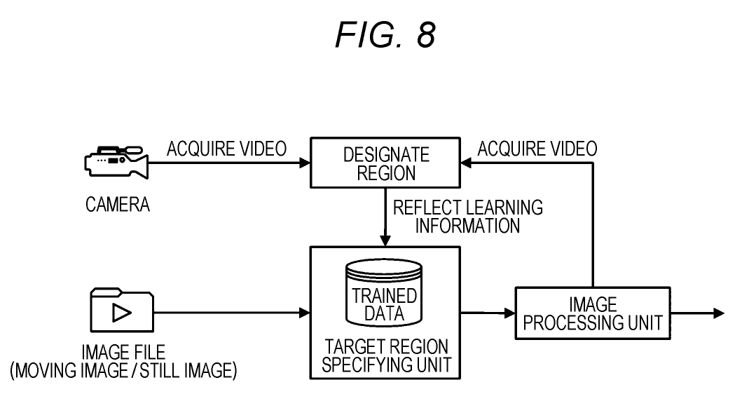

FIG. 8 is a conceptual diagram illustrating a flow in which a video and a video obtained as a result of image processing is reflected in reconstruction of the trained data. As described above, when the video captured by the camera is acquired, the parameters of the trained model are finely tuned based on the region designation (region specifying information) input by the operator. Here, a processed image obtained through region designation from a camera or a video obtained from an image file and subjected to image processing based on trained data is subjected to region designation again and learning information is reflected, that is, a processing result is fed back, whereby more appropriate image processing can be performed.

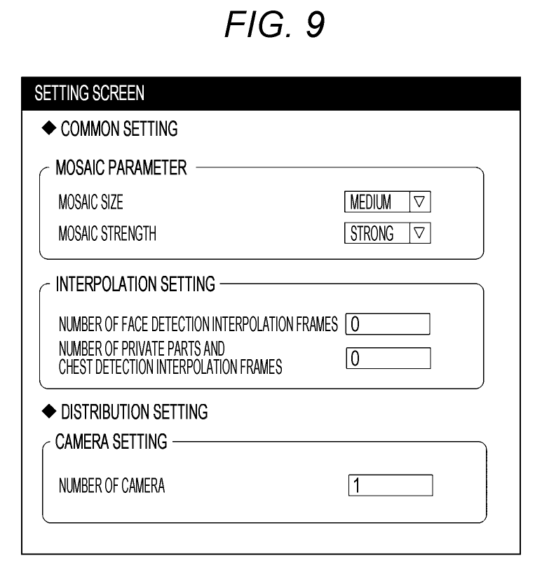

Furthermore, as illustrated in FIG. 9, the size and strength of the mosaic, and the number of interpolated frames of the face, private parts, and chest can be set and input through the detailed setting window of the shielding processing (in this case, mosaic processing) and the interpolation setting (step S407). The size of the mosaic can be configured to be selectable from, for example, “large, medium, and small” in a pull-down menu, and the strength of the mosaic can be configured to be similarly selectable from, for example, “strong, medium, and weak” in a pull-down menu. In addition, a camera to be used at the time of distribution can be configured to be set. After selecting the person/part in the above-described test mode and performing the setting input, the distribution capturing is started (step S408). The image processing apparatus 1 performs image processing on a selected part of a designated person with predetermined settings. Thereafter, the processed image is output (step S409).

5. Others
Note that, among the elements included in the image to be distributed, there may be a case where an object that does not need to be processed has a confusingly similar shape and color of private parts/chest and is likely to be erroneously detected. Also in this case, it may be configured such that input processing of "shielding processing is unnecessary here" can be performed from the outside for the image recorded at the time of test capturing. As illustrated in FIG. 7, it is possible to designate a region on the screen and to designate by pressing a "designate as processing target excluded part" button. Imaging is performed for a predetermined period (for example, about several tens of seconds), and additional learning is performed. As a result, it is possible to avoid reduction in the interest of the viewer due to excessive image processing.

Note that, when the processing target excluded part is designated, information of each of the processing target part and the processing target excluded part is acquired for each frame of the video, and in a case where there is an overlap on the image display and the processing target excluded part is displayed, the overlapping region is excluded from the shielding processing target, and in a case where the processing target part is displayed, the overlapping region is processed as the shielding processing target. In a case where the processing target part partially overlaps and the processing target part is partially displayed, the shielding processing is performed only on a region not overlapping the processing target excluded part in the processing target part. In addition, the processing is applied only when the following conditions are satisfied.
It is clear that the region designated as the processing target excluded part is not a shielding processing target region such as private parts. Specifically, the image processing apparatus 1 stores the image data of the designated region as the processing target excluded part on condition that the image data does not match the processing target.
The coordinates of the region designated as the processing target excluded part do not change significantly. If the position on the image moves significantly, reconfirmation may be performed and the application may be canceled.

Interpolation Processing Note
Note that the interpolation processing by tracking or the like can be applied to the region specified in the test mode, similarly to the region in which the part is specified in the first image processing.

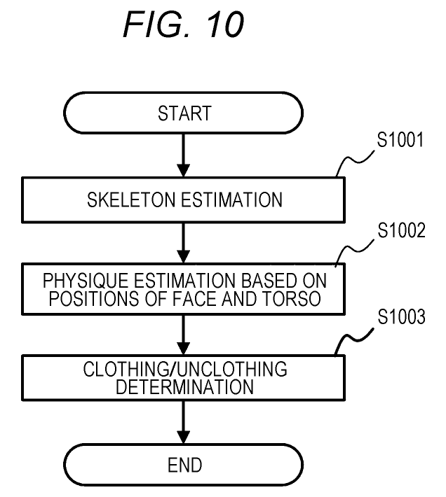

Flow of Second Image Processing
Next, a flow of a second image processing using the trained model in combination with the others will be described with reference to FIG. 10. Hereinafter, it may be referred to as "second image processing".

In the second image processing, the relative position between the private parts and the chest is estimated based on the skeleton model and the positional information of the face. Specifically, the procedure is as follows.

1. Skeleton estimation (step S1001):
Skeleton estimation models are used to identify the structure of the entire body. As an example of the skeleton estimation model, it is possible to use a result of analyzing the positional relationship of each part of the human body by machine learning, or to apply a 3D model such as a skinned multi-person linear model (SMPL) or a 2D skeleton estimation library such as OpenPose, but the present invention is not limited thereto. As a specific method of specifying the structure of the entire body, joint points such as the head, the shoulder, the elbow, the waist, the thigh, and the ankle are detected. Then, the regions of private parts and chest are estimated. In the case of the private parts, it is estimated that the private parts exist in the vicinity of the center of the pelvis portion from the center to the lower portion of the waist, and a rectangular region having a specific size is generated with the vicinity of the center of the pelvis as a starting point. In the case of the chest, the position is estimated slightly downward from the midpoint of both body sides, and the chest region is generated based on the position of the shoulder. The relative positions of the private parts and the chest can be estimated from the pelvic portion.

2.Physique estimation based on the positions of the face and the torso (step S1002):
A face detection model (examples: YOLOv5, RetinaFace) is used to obtain a rectangular region and a center point of the face. For the size of the human body, a distance to each part of the human body is estimated based on the width and height of the face. The position of the chest is estimated at a certain ratio below the center point of the face. Regarding the private parts, the height of the entire torso is estimated from the center point of the face, and the position is set in the vicinity of the lower end thereof. In the estimation, the position of the private parts/chest is estimated in consideration of the height and proportion of the subject. Note that the physique estimation based on the positions of the face and the torso is a process in a case where detection cannot be performed even with skeleton estimation.

3. Clothing/unclothing determination (step S1003):
The clothing/unclothing is determined with reference to the trained data. Note that the clothing/unclothing determination and the physique estimation do not necessarily have to be in this order, and the order may be reversed. In addition, parallel processing may be performed.

Priority Application of Each Image Processing (First and Second)
Each of the above image processing may be executed alone or in parallel. In addition, the processing may be executed in a mutually complementary manner. In the case of being executed in a mutually complementary manner, other image processing may be executed in a mutually complementary manner while setting the first image processing having a relatively light processing load as a base. Also in the case of live distribution, it is possible to perform retraining based on the information of the processing target part designated in the test mode or the processing target excluded part while setting the first image processing as a base. In the present embodiment, the control unit 5 functions as a first target region specifying unit using the trained model stored in the storage unit 6, and functions as a correction target region specifying unit based on input information from the input unit 2.

Interpolation Processing Score
Since the second image processing has a relatively large processing load, it is preferable to intermittently and supplementarily execute the second image processing particularly in the processing of the live distribution image. The second image processing can be configured to be activated according to an "interpolation processing score" given as a result of the first image processing and the interpolation processing. In a case where the interpolation processing continues in a plurality of frames, the "interpolation processing score" decreases, and the second image processing is executed. In executing the second image processing, the control unit 5 functions as a second target region specifying unit.

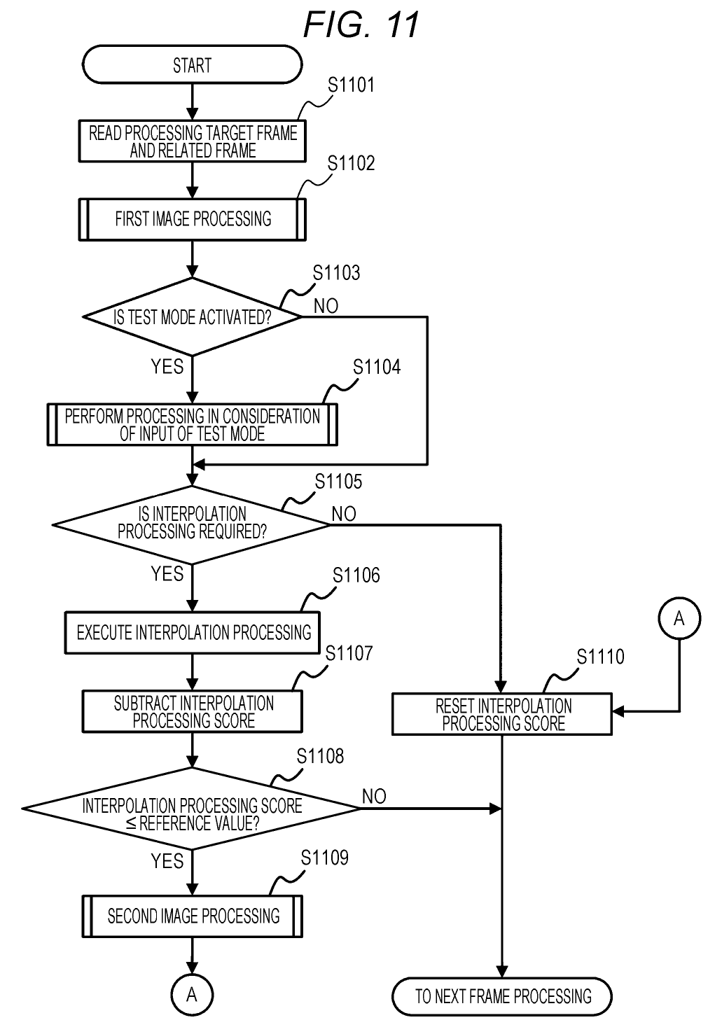

FIG. 11 is a processing flow in a case where each piece of image processing is executed in a mutually complementary manner. The image processing apparatus 1 reads the processing target frame and the related frame, that is, a plurality of frames necessary for performing the interpolation processing and continuous with the processing target frame (step S1101). The image processing apparatus 1 performs the first image processing described above on the read frame (step S1102). When the test mode is activated, processing is performed in consideration of information of a processing target region and a non-processing target region input from the outside in the test mode (steps S1103 and S1104).

The image processing apparatus 1 determines whether or not the interpolation processing is necessary (step S1105). Here, the case where the interpolation processing is necessary means a case where the target region can be specified in the previous frame, but the target region cannot be specified in the first image processing although the target region is in the unclothed state. When it is determined that the interpolation processing is necessary (step S1105=YES), the image processing apparatus 1 performs the interpolation processing and subtracts the interpolation processing score by a predetermined value (steps S1106 and S1107). Here, the initial value setting and the subtraction value setting of the interpolation processing score can be set in consideration of the possibility of occurrence of deviation from the image region to be originally processed by continuously performing the interpolation processing on a plurality of frames. For example, in a case where it is determined that the risk of exposure is increased by the interpolation processing of 0.5 seconds (=15f) in the image of 30 fps, an appropriate mutual interpolation processing can be realized by setting the initial value of the interpolation processing score to a value larger than the reference value by 15.

When the interpolation processing score exceeds the result reference value after subtraction (step S1108=NO), the processing of the frame is ended, and the processing proceeds to the processing of the next consecutive frame. When the value is equal to or less than the reference value (step S1108=YES), the image processing apparatus 1 executes the second image processing (step S1109), returns the interpolation processing score to the initial value (step S1110), and proceeds to the next frame processing. When it is determined that the interpolation processing is unnecessary (step S1105=NO), the interpolation processing is not performed, the interpolation processing point is reset, and the processing proceeds to processing of the next frame.

In the above example, the processing of subtracting the predetermined value is performed in the calculation of the interpolation processing score, but the present invention is not limited thereto, and the processing may be performed by addition, or may be performed by a multiplication method, a division method, a exponentiation, a exponentiation root, or a calculation method combining these methods.

Implementation of Parallel Processing
Note that processing can be distributed by hardware including a plurality of GPUs in order to cope with high-resolution moving images such as 4K and 8K and an increase in the number of frames. Specifically,
1. Minimization of delay in live broadcasting In order to suppress a delay of live broadcasting, a certain number of frames (for example, one second) are buffered and processing is performed. The frames in the buffer are divided among a plurality of GPUs, and each frame is processed in parallel.
2. Image processing load distribution
   In the present embodiment, the first image processing and the processing including the data use in the test mode and the clothing/unclothing determination are configured as processing to be performed on all frames. In order to improve the processing speed in the high-resolution moving image, the processing is parallelized across a plurality of GPUs. Also, while measuring the processing speed, the resource usage of the GPU is dynamically monitored, and the number of GPUs allocated to the first image processing is optimized.
3. Allocate specific GPU for interpolation processing and execution of second image processing In the present embodiment, the interpolation processing and the second image processing are applied to the unprocessed frame and the detection omission in the first image processing as described above, but the load between the GPUs is distributed by using a GPU resource different from that of the first image processing in the interpolation processing and the second image processing. The number of GPUs used for the interpolation processing and the second image processing is dynamically determined after confirming the total number of GPUs mounted on the machine.
4. Efficient utilization of multi-GPU
   The overall number of GPUs is checked to determine the number of GPUs preferentially allocated to the first image processing. The remaining GPUs are allocated to the interpolation processing and the second image processing to ensure scalability of the entire system. In order to equalize the processing load between the GPUs, dynamic scheduling is performed, and load distribution is realized in real time.
5. Integration of results and calculation of risk score The results processed by each GPU are combined to calculate a risk score for each frame. When the risk score exceeds a certain value, a precautionary measure such as mosaic over the entire screen or frame thinning is activated. Note that the determination based on the risk score is basically assumed to be based on the risk score in a single frame, but determination based on an integrated value or an average value of the risk scores in a plurality of predetermined consecutive frames may be performed so as not to excessively perform the shielding processing.

Index of Precautionary Measure: Risk Score
Note that, as a premise of the execution determination of the precautionary measure, a risk score is calculated for each frame as an index indicating the degree to which exposure is likely to occur. As a situation where omission of processing, that is, exposure is likely to occur, for example, the following is considered. In a case where individual risk scores corresponding to the situation are given and the sum of the risk scores in each frame reaches the threshold, the image processing apparatus 1 executes a precautionary measure.
Examples of the situation in which exposure is likely to occur include the following.
- The target part is partially hidden, and the size of the detection region is greatly reduced as compared with the region detected in the previous frame.
- The color and shape of the target part are similar to those of the background: when the hue similarity and the luminance difference (contrast) of the background region are calculated and the difference is small,
- When the movement is intense: when the moving speed of the subject between frames is calculated and is equal to or more than a predetermined value, or when the tracking error is equal to or more than a predetermined value
- Partial disappearance of subject: in a case where the region of the detection region of the subject sharply decreases, in a case where tracking is interrupted in consecutive frames
- Complex background or illumination condition: when the subject is affected by a change in illumination condition (dark place, backlight) or a complex background (outdoor, textured wall)
A risk score corresponding to each case is determined, and the risk score corresponding to each case is calculated for each frame in consideration of a relationship with preceding and subsequent frames. The above is an example of a situation in which a risk score is assigned, and the present invention is not limited thereto. In addition, the risk score does not need to be a fixed value for each scene, and for a situation that can be quantitatively grasped, for example, a change in luminance between frames or a texture feature amount of a background, the risk score may be increased or decreased according to the change amount or the magnitude of the feature amount.

Specific Method of Precautionary Measure
When the risk score exceeds the predetermined threshold as described above, it is determined that the target region is not specified, and the shielding processing is performed on the entire region of the image of the frame. Note that, in a case where the face region is specified, the shielding processing can be performed on a predetermined region, that is, the entire region excluding the specified face region. Furthermore, the frame may be deleted from the moving image data or replaced with another image.

Audio Data/Comment Data
Furthermore, in particular, in the image processing of live distribution, a process of correcting the shielding processing on the basis of audio data or comment data (data written to the chat by the viewer) separately from the video data can be installed.

Examples of the trigger for correcting the shielding processing as the audio data include the following.
1. Utterance of a word directly or indirectly suggesting exposure (examples: “I will be totally naked”, “I can see everything”, and the like)
2. Non-verbal sound evoking exposure (example: non-languaged noise of a person or rhythmic movement sound)
3.Voice tone with heightened emotion

When the audio data is used as a trigger for the shielding processing correction, the audio data may be converted into a text using given voice recognition processing and natural language processing, and determination may be made on the basis of the text. Alternatively, the determination may be made using a discriminator obtained by performing machine learning on the audio data without depending on the processing of conversion into text.

Examples of the trigger for correcting the shielding processing as the comment data include the following.
1. Receive chat including word that directly evokes exposure (examples: totally naked, stark naked, lower body, words indicating private parts, and other slang or argots)
2. Receive chat including word that indirectly evokes exposure (examples: see-through, is this OK?, and the like)

On the basis of the occurrence of the trigger in the audio data or the comment data, the processing proceeds to the correction step of the shielding processing. Specifically, it is determined that the first image processing and the processing in the test mode are not sufficiently performed, and the execution of the interpolation processing and the execution processing of the second image processing are performed.

As still another embodiment, for example, the following can be adopted as a measure for the subject.
1. Before capturing, a paint that reacts to light of a specific wavelength, for example, a UV-fluorescent paint or a UV-absorbing paint, is applied to a part of a human body that is a subject requiring shielding processing. By detecting the application site using the UV camera in combination, it becomes easy to detect that the applied site is the processing required part, the recognition accuracy is improved, and the possibility of processing omission is reduced. Furthermore, by using a UV pass filter suitable for indoor capturing in combination, the influence of external light and illumination can be suppressed, and the recognition accuracy can be further improved. Here, examples of the "UV-fluorescent paint" include Invisible Transparent UV Reactive Paint manufactured by GLO Effex. Examples of the "UV camera" include ARTCAM-2020UV series (manufactured by ARTRAY Co., Ltd.). As the UV pass filter, a commercially available ultraviolet band pass filter can be appropriately adopted.

2. A seal on which a code is printed is attached near a part to be subjected to shielding processing (private parts, chest, and the like). The code may be a barcode or a two-dimensional barcode, and it is desirable that the seal be skin-colored or transparent. By adopting the UV ink, the near-infrared reflective ink, the thermal ink, and the like as the ink for printing the code, the code itself is not visible to the viewer, and on the other hand, by using the UV camera or the infrared camera as the camera together with the capturing camera, the recognition accuracy of the processing required part is improved, and the possibility of processing omission can be reduced. Here, each ink may be each commercially available general ink, and it is sufficient that the printing portion can be recognized by a UV camera or an infrared camera.

3. Biological data (Heart rate, blood pressure, respiratory rate, skin temperature) is monitored by attaching a wearable device to a performer who is a subject. In a case where a significant change amount is recognized in the biological data even though there is no large movement of the body on the imaging screen, it is determined that the frame requires shielding processing as the excitation state of the subject, and the processing is performed. As a shape of the wearable device, in addition to a smart watch type worn on a wrist like a wristwatch, a smart glass type, a ring type, or the like can be appropriately adopted as long as biological data can be monitored.

4. Alternatively, a marker for optical motion capture or an inertial sensor is attached to a performer who is a subject, and motion analysis is performed simultaneously at the time of capturing. As a result, the skeleton structure of the subject can be grasped at the same time as the capturing, and the processing corresponding to the second image processing can be performed on all the frames of the moving image by being synchronized with the capturing data.

Alternatively, for example, the following may be adopted as an imaging method using a device or a sensor in combination.
5. It is possible to detect the temperature difference between the clothed portion and the unclothed portion by using a thermographic camera in combination for improving the accuracy of the clothing determination. In addition, by applying the thermographic camera, it is easy to grasp the position and posture of the human body or to detect the body part with increased blood flow, and the accuracy of the shielding processing can be further improved.

6. Alternatively, by embedding an ultra high frequency radio frequency identification (UHF RFID) tag in underwear and monitoring the presence or absence of clothing with a UHF RFID reader, the recognition accuracy of clothing/unclothing can be improved. In this case, it is possible to configure such that the RFID tag of the imaging region is registered in advance at the stage of pre-registration (test capturing) of the test mode, and when the RFID tag registered in advance cannot be recognized at the distribution stage, it is determined that the user is unclothed, and the shielding processing is applied.

7. The vibration sensor is installed near a body part requiring shielding processing, for example, on an arm of a subject or a chair, a desk, bedding, or the like used by the subject, and periodic vibration different from normal operation is analyzed. When a specific vibration pattern continues for a certain period of time, it is determined that an activity requiring shielding processing is being performed, and the shielding processing is executed.

8. By installing the pressure sensor on the surface or inside of furniture arranged at the capturing place, for example, a chair or a bed, it is detected that the person who is the subject changes the posture. In a case where a change in posture is detected, it is determined that an activity requiring the shielding processing is being performed or there is a possibility that an image region requiring the shielding processing has newly occurred, and the shielding processing is executed.

9. Capturing is performed in a state where the electrostatic capacitance proximity sensor is attached in the vicinity of private parts, a chest, or a hand of a person as a subject. In a case where it is detected that the private parts or the chest and the hand approach each other, it is determined that an activity requiring shielding processing is being performed, and the shielding processing is executed.

Furthermore, in particular, the following method can be adopted as a method of using a history in moving image distribution or an action of a viewer as a trigger of shielding processing.
10. A learning model is constructed in which distribution data of which violation/warning has been received in the moving image distribution platform in the past, for example, distribution data of a distributor whose account has been suspended, or the like is fetched as training data, and a frame in which a behavior pattern with a high risk is captured is detected from the captured image data before distribution, and the shielding processing is performed or the frame deletion is performed.

11. A rapid increase or a specific pattern of the tips of the viewer who views the moving image distribution, that is, tipping for the moving image is analyzed to detect the possibility of exposure. In particular, it is possible to focus on the behavior history of the user who provides the tip, train the relationship between the timing at which the part to be shielded is exposed and the timing of providing the tip, and perform the shielding processing on the basis of the obtained learning model.

What is claimed is:

1. An image processing apparatus comprising:
an image input unit that inputs an image in which at least one human body is captured;
a target region specifying unit that specifies a target region (however, the face region is excluded) in the image; and
an image processing unit that performs shielding processing on the specified target region,
wherein the shielding processing includes any one or a plurality of mosaic processing, blurring processing, blending processing, processing of superimposing another image on the target region, and processing of replacing the image with another image,
the target region specifying unit includes any one or a plurality of
a first specifying unit that specifies a region detected by a model constructed by machine learning as a target region,
a second specifying unit that specifies the target region by correcting the constructed model based on a feature amount of a region specified by an external operation, and
a third specifying unit that specifies a non-target region based on a feature amount of a region specified by an external operation.

2. The image processing apparatus according to claim 1, wherein the model in the first specifying unit detects the target region by using an algorithm pre-trained by machine learning using a clothed or unclothed state of a human body as training data.

3. The image processing apparatus according to claim 1, wherein the model in the first specifying unit detects the target region by using an algorithm pre-trained by machine learning using skeleton information or posture information of a human body as training data.

4. The image processing apparatus according to claim 1, further comprising a face region specifying unit that specifies a face region in the image,
wherein a position of the target region specified on the basis of a positional relationship with the face region is corrected.

5. The image processing apparatus according to claim 1, wherein the image is a moving image, and with respect to a target region specified in one frame, corresponding regions in a plurality of consecutive frames are also regarded as target regions, and interpolation processing is performed.

6. The image processing apparatus according to claim 2, wherein the image is a moving image, and with respect to a target region specified in one frame, corresponding regions in a plurality of consecutive frames are also regarded as target regions, and interpolation processing is performed.

7. The image processing apparatus according to claim 3, wherein the image is a moving image, and with respect to a target region specified in one frame, corresponding regions in a plurality of consecutive frames are also regarded as target regions, and interpolation processing is performed.

8. The image processing apparatus according to claim 4, wherein the image is a moving image, and with respect to a target region specified in one frame, corresponding regions in a plurality of consecutive frames are also regarded as target regions, and interpolation processing is performed.

9. The image processing apparatus according to claim 1, further comprising a risk score calculation unit for each frame, wherein the image is a moving image, and when an integrated value of risk scores in a plurality of consecutive predetermined frames exceeds a predetermined value, shielding processing is performed on a predetermined region of an image after a frame in which the integrated value exceeds the predetermined value.

10. The image processing apparatus according to claim 2, further comprising a risk score calculation unit for each frame, wherein the image is a moving image, and when an integrated value of risk scores in a plurality of consecutive predetermined frames exceeds a predetermined value, shielding processing is performed on a predetermined region of an image after a frame in which the integrated value exceeds the predetermined value.

11. The image processing apparatus according to claim 3, further comprising a risk score calculation unit for each frame, wherein the image is a moving image, and when an integrated value of risk scores in a plurality of consecutive predetermined frames exceeds a predetermined value, shielding processing is performed on a predetermined region of an image after a frame in which the integrated value exceeds the predetermined value.

12. The image processing apparatus according to claim 4, further comprising a risk score calculation unit for each frame, wherein the image is a moving image, and when an integrated value of risk scores in a plurality of consecutive predetermined frames exceeds a predetermined value, shielding processing is performed on a predetermined region of an image after a frame in which the integrated value exceeds the predetermined value.

13. An image processing method comprising:
an image input step of inputting an image in which at least one human body is captured;
a target region specifying step of specifying a target region (however, the face region is excluded) in the image; and
an image processing step of performing shielding processing on the specified target region,
wherein the shielding processing includes any one or a plurality of mosaic processing, blurring processing, blending processing, processing of superimposing another image on the target region, and processing of replacing the image with another image,
the target region specifying step includes any one or a plurality of steps of
a first specifying step of specifying a region detected by a model constructed by machine learning as a target region,
a second specifying step of specifying the target region by correcting the constructed model based on a feature amount of a region specified by an external operation, and
a third specifying step of specifying a non-target region based on a feature amount of a region designated by an external operation.

14. An image processing program causing a computer to function as:
an image input unit that inputs an image in which at least one human body is captured;
a target region specifying unit that specifies a target region (however, the face region is excluded) in the image; and
an image processing unit that performs shielding processing on the specified target region,
wherein the shielding processing includes any one or a plurality of mosaic processing, blurring processing, blending processing, processing of superimposing another image on the target region, and processing of replacing the image with another image,
the target region specifying unit includes any one or a plurality of
a first specifying unit that specifies a region detected by a model constructed by machine learning as a target region,
a second specifying unit that specifies the target region by correcting the constructed model based on a feature amount of a region specified by an external operation, and
a third specifying unit that specifies a non-target region based on a feature amount of a region specified by an external operation.

15. An image processing apparatus comprising:
an image input unit that inputs a video in which at least one human body is captured;
a target region specifying unit that specifies a target region (however, the face region is excluded) in each of consecutive frames constituting a video; and
an image processing unit that performs shielding processing on the specified target region,
wherein the target region specifying unit includes
a first target region specifying unit that specifies a region recognized using a trained model constructed by machine learning as a target region, and
a second target region specifying unit that executes processing when interpolation processing occurs in a predetermined number of consecutive frames.

16. The image processing apparatus according to claim 15, further comprising a correction target region specifying unit that specifies, as a target region, a region recognized using a trained model reconstructed on the basis of image information of a region specified by an external operation in the video, in parallel with the specification by the first target region specifying unit.

17. The image processing apparatus according to claim 15, further comprising a correction target region specifying unit that specifies, as a target region, a region recognized using a trained model reconstructed on the basis of image information of a region specified by an external operation in the video, after specification by the first target region specifying unit.

18. The image processing apparatus according to claim 15, wherein a processing load of the second target region specifying unit is larger than that of the first target region specifying unit.

19. The image processing apparatus according to claim 15, wherein the processing by the second target region specifying unit uses both a skeleton estimation model and a face detection model.
